(19) United States
(12) Patent Application Publication
(10) Pub. No.: US 2014/0260124 A1
(43) Pub. Date: Sep. 18, 2014

(54) HORSE BIT

(71) Applicant: Vaughn A. KNUDSEN, Morgan, UT (US)

(72) Inventor: Vaughn A. KNUDSEN, Morgan, UT (US)

(21) Appl. No.: 13/827,864

(22) Filed: Mar. 14, 2013

(51) Int. Cl. B68B 1/06

(52) U.S. Cl. CPC B68B 1/06
USPC 54/8

(57) ABSTRACT

A horse bit includes attachment members to which a horse bridle is attachable, a mouthpiece connected to the attachment members, protrusions protruding from the mouthpiece. The protrusions are each positioned to apply outward pressure to a zygomaticus muscle of a horse.

### BACKGROUND

Many different styles of horse bits are known. To guide a horse to turn its head, known bits apply inward pressure to the outside of a horse's cheek or mouth.

### SUMMARY

As used herein, the term “horse” is used broadly, to encompass not only horses but also other equids such as mules and donkeys. The term “inward” refers to a lateral direction from outside of a horse's mouth toward the inside of the horse's mouth, and the term “outward” refers to a lateral direction from inside a horse's mouth toward the outside of the horse's mouth.

In embodiments of the invention, protrusions on the mouthpiece of a bit fit against the inside corner of a horse's mouth, between (i) the inside of the muscles of the horse's cheek and (ii) the horse's teeth. Each protrusion guides the horse when it touches against the skin of the cheek inside the mouth, thereby exerting outward pressure on the inside of the cheek. The inventor has found that these protrusions achieve a remarkable effect on the behavior of the horse, causing the horse to respond quickly and with little or no resistance, even though only a small amount of pressure is exerted by the rider.

When carrying a rider, it is desirable that a horse's nose be positioned slightly inward, i.e., with the nostrils relatively closer to the horse's chest. It is undesirable for the horse's head to be flexed outward such that the nostrils are relatively far from the horse's chest. When a horse objects to the bit and/or actions of the rider, it sometimes shows its objection by tightening certain muscles in the head and neck, causing the head to flex forward and pushing its nose against the pressure of a bit. It is believed that the protrusions achieve their remarkable effect by causing a certain muscle in the horse's mouth structure, i.e., the zygomaticus muscle (which attaches to the orbicular muscle), to soften and relax.

These and other features and advantages are described in or will become apparent from the following detailed description.

### BRIEF DESCRIPTION OF THE DRAWINGS

Embodiments will be described with reference to the attached drawings, in which like reference numerals represent like parts, and in which:

FIG. 1 is a perspective view of a horse bit according to a first embodiment;

FIG. 2 is a perspective view of a horse bit according to a second embodiment;

FIG. 3 is a perspective view of a horse bit according to a third embodiment; and

FIG. 4 is a perspective view of a horse bit according to a fourth embodiment.

### DETAILED DESCRIPTION OF EMBODIMENTS

FIG. 1 shows a horse bit 10 according to a first embodiment. The horse bit comprises a mouthpiece 100, protrusions 114 protruding from the mouthpiece 100, and attachment members 200. The mouthpiece 100 is hinged at hinge point 112. However, in other embodiments (not shown), a rigid mouthpiece, with no hinge point, is used. The shape and style of the mouthpiece is not limited. The attachment members 200 in this embodiment are in the form of rings, to which a bridle (not shown) and reins (not shown) are attachable in a known manner.

In use, the bit 10 is positioned in the horse's mouth in such a manner that the protrusions 114 are placed outside the horse's teeth, but inside the horse's cheek. In other words, each protrusion 114 is between the horse's teeth and cheek. The protrusions in this embodiment are in the form of flanges that extend around the mouthpiece 100.

When a rider pulls the rein attached to the attachment member 200 at one side of the bit 10, the protrusion 114 on that side exerts outward pressure on the zygomaticus muscle on that side of the horse's mouth.

A distance between the protrusions 114 as measured along the mouthpiece 100 (referred to hereafter as simply the “distance between protrusions”) may be selected for an individual horse on which the bit 10 will be used, based on the width of the horse's mouth, and more particularly, the width of the mouth at the point at which the bit passes through. Alternatively, the distance between protrusions may be selected for a particular breed of horse. For example, some breeds of horses tend to have narrower mouths than other breeds.

In general, the distance between protrusions 114 should be in a range of from about 3 inches to about 5 inches. If the distance is shorter than 3 inches, the protrusions 114 may not fit outside the horse's teeth, and if the distance is longer than 5 inches, the protrusions 114 may not fit inside the horse's cheeks.

The length L of each protrusion 114, as measured from the mouthpiece to the tip of the protrusion 114, is preferably in a range of from about ½ inch to about 1½ inches, but any length is acceptable as long as the protrusions 114 achieve the desired effect, and fit within the space between the teeth and cheeks of a horse.

FIG. 2 shows a horse bit 20 according to a second embodiment. The bit 20 has attachment members 300 of a style in which a bridle attached to ends 302, and reins attach to ends 304. The protrusions 214 in this embodiment are in the form of relatively flat plates that extend from one side of the mouthpiece 100.

FIG. 3 shows a horse bit 30 according to a third embodiment. The third embodiment is similar to the first embodiment, but has protrusions 314 formed in the shape of rods with balls at the end.

FIG. 4 shows a horse bit 40 according to a fourth embodiment. The fourth embodiment is similar to the first embodiment, but has protrusions 414 formed in the shape of elongated loops.

While the invention has been described in conjunction with the specific embodiments described above, these embodiments should be viewed as illustrative and not limiting. Various changes, substitutes, improvements or the like are possible within the spirit and scope of the invention.

For example, although protrusions of various shapes have been depicted, many other shapes are possible. Similarly, although specific styles and/or shapes of bits have been depicted, the invention is also applicable to any other shape and style of bit.

What is claimed is:

1. A horse bit, comprising:
attachment members to which a horse bridle is attachable;
a mouthpiece connected to the attachment members; and
protrusions protruding from the mouthpiece, the protrusions each being positioned to apply outward pressure to a zygomaticus muscle of a horse.

2. The horse bit of claim 1, wherein a distance between the protrusions, as measured along the mouthpiece, is in a range of from about 3 inches to about 5 inches.

3. The horse bit of claim 2, wherein a length of each protrusion, as measured from the mouthpiece to an end of the protrusion, is in a range of from about ½ inch to about 1½ inches.

4. The horse bit of claim 1, wherein a length of each protrusion, as measured from the mouthpiece to an end of the protrusion, is in a range of from about 3 inches to about 5 inches.

5. A method of guiding a horse, comprising:
inserting the horse bit of claim 1 into a horse's mouth; and
applying outward pressure to a zygomaticus muscle of the horse by pulling outward on one of the attachment members.
